(19) United States
(12) Patent Application Publication
(10) Pub. No.: US 2008/0285731 A1
(43) Pub. Date: Nov. 20, 2008

(54) SYSTEM AND METHOD FOR NEAR-REAL-TIME VOICE MESSAGING

(75) Inventors: Myroslav Mykhalchuk, Lviv (UA); Denys Spektor, Lviv (UA); Yuriy Mykhalchuk, Rohatyn (UA); Anna Tsybko, Lviv (UA)

Correspondence Address: DUBOIS, BRYANT, CAMPBELL & SCHWARTZ, LLP, 700 LAVACA STREET, SUITE 1300, AUSTIN, TX, 78701, US

(73) Assignee: Say2Go, Inc., Austin, TX (US)

(21) Appl. No.: 12/120,926

(22) Filed: May 15, 2008

Related U.S. Application Data
(60) Provisional application No. 60/917,980, filed on May 15, 2007.

(51) Int. Cl. H04M 11/00

(52) U.S. Cl. 379/88.14

(57) ABSTRACT

A system and method for near-real-time messaging is provided. Users may transmit and receive recorded audio inputs in near-real-time using communications devices that are connectible to a network. The system and method also provides for optional speech-to-text translations and transmission of such text translations between communications devices.

### CROSS-REFERENCE TO RELATED APPLICATIONS

This non-provisional application claims priority based upon prior U.S. Provisional Patent Application Ser. No. 60/917,980 filed May 15, 2007 in the name of Myroslav Mykhalchuk, Denys Spektor, Yuriy Mykhalchuk, and Anna Tsybko, entitled “Near-real-time voice messaging with optional speech-to-text recognition,” the disclosure of which is incorporated herein by reference.

### BACKGROUND OF THE INVENTION

The present invention is related generally to network communications systems and, more particularly, to voice communication over computer networks.

A form of textual communication over computer networks, such as the Internet, known as “instant messaging” is gaining ever increasing popularity among computer network users. The advantage of instant messaging is that two or more individuals may engage in an ongoing electronic “chat” by simply typing the message on the keyboard, without having to enter the address of recipients each time. One of the first systems of this type was the UNIX “talk” program, which performs a character-by-character transmission of an instant message. That is, each time an individual types of a single character on the computer keyboard, that character is transmitted to all other participants in the instant messaging session. Because other participants are essentially watching the person type, this type of messaging is referred to as “instant”. However, this approach has several limitations. First, most users prefer not to be “watched” as they type so that they could correct their incomplete thoughts and typing errors prior to transmission. Also, message recipients are distracted by watching the flickering screen in which characters appear one by one as the message is formed. In addition, character-by-character transmission significantly increases the network traffic because each character requires one or more data packets to be sent to each participant in the instant messaging session.

Therefore, what is today referred to as “instant messaging” has evolved from the true instant textual messaging (e.g. UNIX “talk”) to the presently dominant mode which is in fact a near-real-time textual messaging. In near-real-time mode, the sender can complete his thoughts and correct any typing errors prior to transmission, and only then initiate the transmission by e.g. pressing the “Enter” button on the computer keyboard or clicking on a “Send” icon on the computer display screen. Such “instant messaging” services include AOL Instant Messenger, for which software is commercially available from AOL LLC., Windows Live Messenger, commercially available from Microsoft Corporation, Yahoo! Messenger, commercially available from Yahoo! Inc., and Google Talk, which is based on Jabber (a set of open instant messaging protocols) and commercially available from Google.

At the same time, voice communication over computer networks is increasingly popular. When transferred over the Internet, voice-over-IP (“VoIP”) technology is widely used. At present, voice communication over computer networks is mainly instant, i.e., the recipient of the voice message listens to the message as the sender speaks, with only a negligible delay caused by digitizing the voice, transmitting it over the network, and playing it back to the recipient. This mode closely emulates talking over a regular telephone. It has its drawbacks, such as being intrusive (requiring the recipient to start listening to the message immediately rather than be able to postpone listening until it's more convenient) and lacking textual search capability through the voice communication history. Those rare services which implement offline voice communication, such as GoogleTalk voicemail service or Jott, commercially available from Jott Networks Inc., tend to emulate regular voicemail systems. These existing services allow recording a voice message through one system such as Google Talk messenger or a mobile telephone while delivering the message to another system such as e-mail or the Short Message Service protocol (“SMS”), and thus are not well suited for near-real-time exchange of voice messages between two or more users of messenger systems.

Therefore, in appreciation of dominant popularity of near-real-time mode in textual messaging, it can be appreciated that there is a significant need for a system and method that will provide near-real-time mode in voice communication over computer networks. Further, it can be appreciated that the near-real-time voice communication method which is the subject of this invention separates voices of individual users in time and provides a slack time for processing, thus technically enabling reliable speech-to-text recognition. Still further, it can be appreciated that the near-real-time voice communication method allows emulating widely used Push-To-Talk mode of telecommunication. The present invention provides these and other advantages, as will be apparent from the following detailed description and accompanying figures.

### BRIEF SUMMARY OF THE INVENTION

A system which implements a preferred embodiment of the present invention includes a multiplicity of communications devices, connectable to a computer network such as the Internet. Communications devices are preferably operative to receive audio inputs via built-in or standalone microphones from users and deliver audio outputs via built-in or standalone audio reproducing devices to users. As well, communications devices are preferably operative to transmit and receive information via computer network to and from at least one server.

A messenger, which is typically resident in communications device, in a preferred embodiment of the present invention connects to a messaging server, which is typically resident in at least one server and in one embodiment of the present invention implements and extends Jabber set of open instant messaging protocols. Messengers are connectable to at least one messaging server thus fulfilling common messaging functions such as user authorization, maintaining lists of sought users known as “buddy lists”, exchanging presence information, and the like. Additionally, for the purposes of this invention, messaging server is operative to receive and transmit audio recordings from and to messengers. These audio recordings typically include voice messages which users send to themselves and/or to other users of the system.

Additionally, one embodiment of the present invention includes a speech-to-text recognition server which is operative to receive voice recordings from and return recognized text to messaging server. Another embodiment of the present invention, makes use of speech-to-text recognition capabilities of users' communications devices, thereby replacing the speech-to-text recognition server. Messaging server then transmits recognized text to messengers used by the sender and the intended recipients of the voice message. Recognized text is preserved in messaging history coupled with original voice recordings, thus enabling textual search through history of voice messaging.

Further, in a preferred embodiment of the present invention, speech-to-text recognition server is operative to capture and preserve the profile of each user and apply this profile to enhance quality of speech-to-text recognition of further voice messages sent by this user. This profile is additionally used to provide a service of identification and authentication of the user in a computer network such as the Internet, preferably along with commonly used textual login/password identification and authentication.

Still further, a preferred embodiment of the present invention includes a voice messenger editor. Voice message editor is operative to allow the sender of the voice message to enhance the recorded voice message prior to sending with actions such as cropping the message, merging the message with pre-recorded audio clips such as greetings and “audibles”, superimposing the message over a melody relevant to the subject of the message, storing a draft message in a repository as an audio clip for further editing or sending, and the like. Voice message editor uses information provided by speech-to-text recognition server to provide the user with textual clues along the editor timeline to facilitate the process of editing a voice message.

Further, the message sender may choose to route the voice message to users of other devices such as regular phones connected to a network such as Public Switched Telephone Network. The voice message in this case is routed via a computer network to telephone network gateway. Such gateway services are commercially available from a multiplicity of SIP termination providers, as well as SkypeOut, commercially available from Skype Limited.

Even further, the message sender may choose to schedule the voice message to be sent at a user-specified time and date rather than immediately. When sent to himself or herself, the scheduled voice message may serve as a reminder.

It will be appreciated by those skilled in the art that in another embodiment of the present invention most or all of the employed functions of servers may be replaced by functions built into communication devices and messengers, thus implementing server-less peer-to-peer communication.

### BRIEF DESCRIPTION OF THE DRAWINGS

FIG. 1 is a simplified pictorial illustration of a system that includes components to implement a preferred embodiment of the present invention.

FIGS. 2A and 2B together form a flowchart illustrating the operation of significant functions in a preferred embodiment of the present invention.

### DETAILED DESCRIPTION

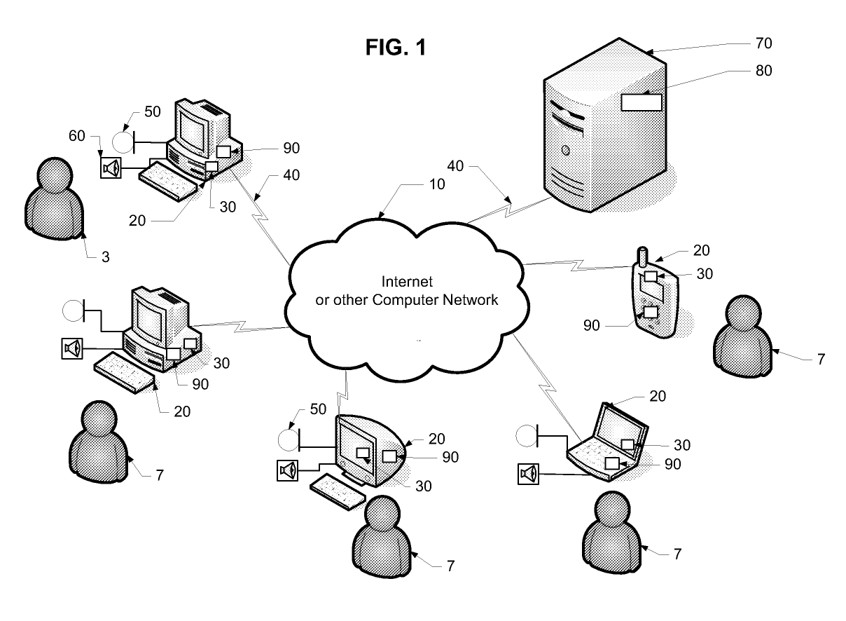

Reference is now made to FIG. 1 which is a simplified pictorial illustration of a system that includes components to implement a preferred embodiment of the present invention.

The system preferably includes a multiplicity of communications devices 20, connectable to a computer network 10 via a multiplicity of connection media 40 which may either be wired or wireless. It will be appreciated by those skilled in the art that communications device 20 can be any device operative to interlace with a preferably human user and execute computer instructions such as a software or firmware program, including but not limited to a personal computer (“PC”), a computer other than PC, a portable computer, a hand-held device, a programmable consumer electronic device, a network PC, or a web application executable platform-independently in a Web browser. The invention may also be practiced in distributed computing environments where tasks are performed by remote processing devices that are linked through a communications network. In a distributed computing environment, program modules may be located in both local and remote memory storage devices. In accordance with the present invention, embodiments described herein to include a computer network may also be implemented with a communications network.

Communications devices 20 are preferably operative to receive inputs, including audio inputs via built-in or standalone devices such as microphones 50, from and deliver outputs, including audio outputs via built-in or standalone audio reproducing devices 60, to users such as 3 or 7. As well, communications devices 20 are preferably operative to transmit and receive information via computer network 10 to and from at least one server 70 which is also connected to computer network 10 via connection media 40. Server 70 is likewise operative to send and receive information via computer network 10.

A messenger apparatus 30, which is typically resident in communications device 20, in a preferred embodiment of the present invention connects to a messaging server 80, which is typically resident in at least one server 70 and in one embodiment of the present invention implements and extends Jabber set of open instant messaging protocols. A multiplicity of messengers 30 are connectable to at least one messaging server 80 thus fulfilling common messaging functions such as user authorization, maintaining lists of sought users known as “buddy lists”, exchanging presence information, and the like. Additionally, for the purposes of this invention, messaging server 80 is operative to receive and transmit audio recordings from and to messengers 30. These audio recordings typically include voice messages which user 3 sends to himself/herself and/or to at least one of the multiplicity of other users 7 of the system.

Additionally, one embodiment of the present invention includes at least one speech-to-text recognition server 90 which is typically resident in at least one server 70 and operative to receive voice recordings from and return recognized text to messaging server 80. Another embodiment of the present invention makes use of speech-to-text recognition capabilities of users' communications devices 20 thereby replacing speech-to-text recognition server 90. Messaging server 80 then transmits recognized text to messengers 30 used by the sender and the intended recipients of the voice message. Recognized text is preserved in messaging history, coupled with original voice recordings, thus enabling textual search through history of voice messaging. The history is preferably stored in communications device 20 where the related messenger 30 is typically resident. In another embodiment of the present invention, the history is stored in server 70.

Further, in one embodiment of the present invention, speech-to-text recognition server 90 is operative to capture and preserve the profile of each user such as 3 or 7 and apply this profile to enhance quality of speech-to-text recognition of further voice messages sent by this user. This profile is additionally used to provide a service of identification and authentication of the user in a computer network such as the Internet, preferably along with commonly used textual login/password identification and authentication.

Still further, a preferred embodiment of the present invention includes a voice messenger editor typically resident in either messenger 30 or at least one Web server 95. Web server 95 is typically resident in server 70. Voice message editor is operative to allow the sender of the voice message such as 3 to enhance the recorded voice message prior to sending with actions such as cropping the message, merging the message with pre-recorded audio clips such as greetings and “audibles”, superimposing the message over a melody relevant to the subject of the message, storing a draft message in a repository as an audio clip for further editing or sending, and the like. Voice message editor uses information provided by speech-to-text recognition server 90 to provide the user with textual clues along the editor timeline to facilitate the process of editing a voice message.

Further, the message sender such as 3 may choose to route the voice message to at least one of a multiplicity of users 9 of other devices such as regular phones 160 connected to a network such as Public Switched Telephone Network. The voice message in this case is routed via a computer network to telephone network gateway 100. Such gateway services 100 include Session Initiation Protocol (“SIP”) terminating services, commercially available from a multiplicity of SIP termination providers, and SkypeOut, commercially available from Skype Limited.

Even further, the message sender such as 3 may choose to schedule the voice message to be sent at a user-specified time and date rather than immediately. When sent to himself/herself, the scheduled voice message may serve as a reminder.

It will be appreciated by those skilled in the art that in another embodiment of the present invention most or all of the employed functions of servers 70, 80, 90, and 95 may be replaced by functions built into communication devices 20 and messengers 30, thus implementing server-less peer-to-peer communication.

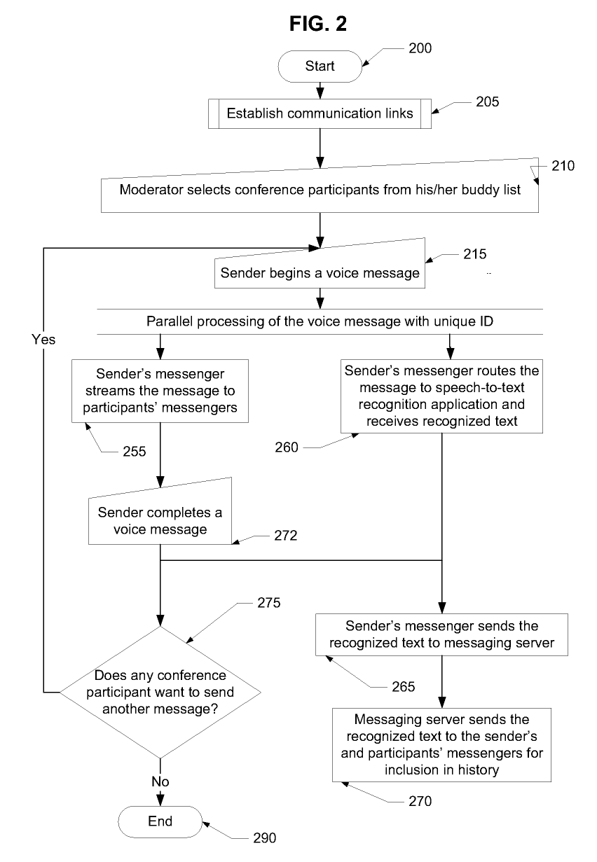

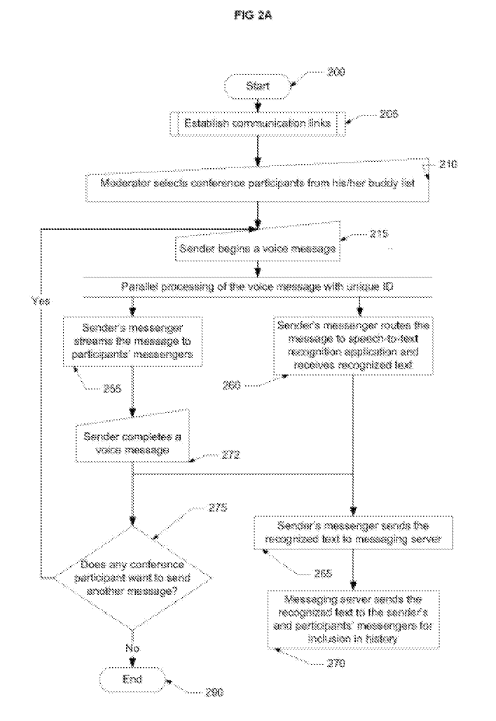

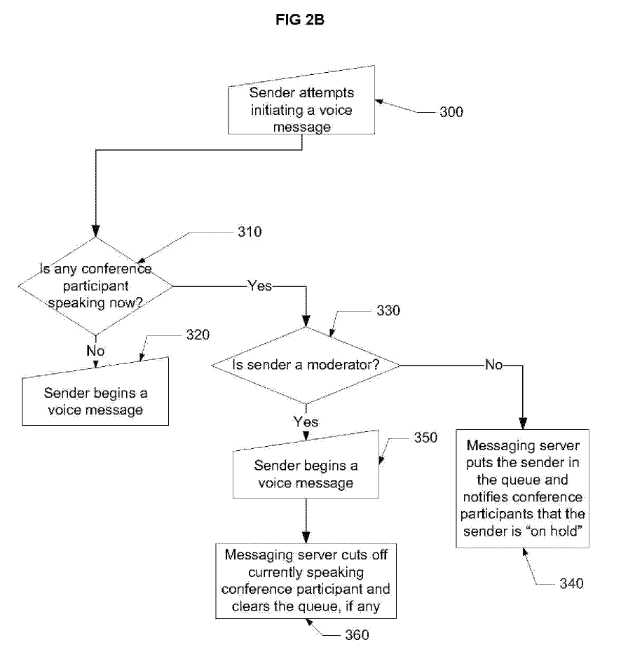

Reference is now made to FIGS. 2A and 2B which together form a flowchart illustrating the operation of significant functions in a preferred embodiment of the present invention. As well, references to components shown in FIG. 1 continue to be used hereinafter. At a start 200, it is assumed that multiple users wish to engage in a voice messaging session. In step 205, messaging communication links are established between participants and the servers. The process of establishing the messaging communication links between participants via the computer network 10 such as the Internet is well-known and need not be described herein.

In step 210, user such as 3, who wishes to send a voice message (hereinafter referred to as the sender), selects at least one of the multiplicity of message recipients from his/her buddy list in messenger 30. The sender's buddy list can include a self-contact which can also be a recipient of the message.

In step 215, the sender records her voice message. In a preferred embodiment of the present invention, the sender presses and holds a configurable button on the communications device 20 to initiate the recording session, and then dictates a message into audio input device such as microphone 50. If communications device 20 is a computer, the configurable button can be, for example, the “Space Bar” on the keyboard or a button on a pointing device. Upon initiating the recording session, messenger 30 assigns the voice message which is being created with a unique identification number (hereinafter referred to as “ID”) and communicates this ID to messaging server 80 along with the notification about the sender preparing a message for the selected set of recipients such as 7.

Simultaneously, messenger 30 starts recording the voice message dictated by the sender. When the message is complete, the sender releases the configurable button, thus acting as in Push-To-Talk systems. Messenger 30 completes recording of the file containing the sender's voice message, and optionally encodes the file in a format convenient for transferring over computer network 10. In another embodiment of the present invention, instead of recording the complete voice message at messenger 30 prior to transmitting it to messaging server 80, messenger 30 employs network streaming to server 80 while the sender is dictating his/her message to shorten the time of transfer of the voice message.

In step 220, messenger 30 provides the sender with a set of options among which the sender is to choose one action on the recorded voice message. In a preferred embodiment of the present invention, these selectable actions include:
a. “Send”—It confirms sending the message as it is. The sending process starts in step 225.
b. “Cancel”—It allows the sender to cancel the message which may have been dictated with an error. Messenger 30 implements this operation in step 230.
c. “Play back”—It allows the sender to listen to the recorded message prior to doing further operations on the message. Messenger 30 implements this operation in step 235 by playing the message back via audio reproducing device such as 60. When the “Play back” operation is complete, messenger 30 returns to step 220 allowing the sender to choose the next operation on the message.
d. “Schedule”—It allows the sender to schedule the message for sending at a time/date specified by the sender rather than immediately. Messenger 30 implements this operation in step 240. When the “Schedule” operation is complete, messenger 30 returns to step 220 allowing the sender to choose the next operation on the message.
e. “Edit”—It allows the sender to enhance the recorded voice message prior to sending with actions such as cropping the message, merging the message with pre-recorded audio clips such as greetings and “audibles”, superimposing the message over a melody relevant to the subject of the message, storing a draft message in a repository as an audio clip for further editing or sending, and the like. The voice message editor, which may be resident in either messenger 30 or Web server 95, uses information provided by speech-to-text recognition server 90 to provide the user with textual clues along the editor timeline to facilitate the process of editing. Messenger 30 implements this operation in step 245.
f. “Send to phone”—It allows the sender to send the voice message to at least one of a multiplicity of users 9 of other devices such as regular phones 160 connected to a network such as Public Switched Telephone Network. The voice message in this case is routed via a computer network to telephone network gateway 100. Messenger 30 implements this operation in step 250.

If the sender selects “Send” option, messenger 30 transfers the file containing the voice message to messaging server 80 in step 225. Further, messaging server 80 initiates two concurrent actions on the voice message starting in steps 255 and 260.

In step 255, messaging server 80 transfers the file containing the voice message to messengers 30 of the selected set of message recipients such as 7.

In step 260, messaging server 80 transfers the file containing the voice message to speech-to-text recognition server 90.

In step 265, speech-to-text recognition server 90, optionally using a prerecorded profile of the sender for enhancing the recognition accuracy, recognizes the voice message into text, and then returns the recognized text back to messaging server 80.

In step 270, messaging server 80 sends the recognized text to messengers 30 of the same set of message recipients as in step 255.

In choice 275, each recipient's messenger 30 verifies if it has got both the file containing the voice message and the recognized text message with the same ID from messaging server 80. If “No”, then messenger 30 waits and returns to choice 275. This waiting period of time is configurable; and in a preferred embodiment of the present invention, the waiting period is set to 1 second. Although not shown on the drawings, warning and failure notifications may also be sent to the sender. If “Yes”, messenger 30 proceeds to choice 280. In another embodiment of the present invention, messenger 30 checks for matching pairs of pending voice messages and recognized text messages each time the messenger 30 receives any new message.

In choice 280, each recipient's messenger 30 verifies if an intercept request with given ID has been received from messaging server 80. As specified in step 252, the sender has an option of generating an intercept request at any time after selecting “Send” action. This request is processed by the system with the highest priority. If Yes, messenger 30 deletes both the file containing the voice message and the recognized text, and then sends the interception confirmation to the sender via messaging server 80. If No, messenger 30 displays the message, in one embodiment of the present invention as an item in a chat window, the recognized text being displayed as a typical instant messaging text message, and the voice file playable via recipient's action such as clicking on a hyperlink being part of the same chat window message.

If the intercept request arrives at the recipient's message after the message with this ID has been displayed, then messenger 30 returns an intercept failure notification to the messaging server 80 or, alternatively, to the sender's messenger 30. This process is not shown on the drawings.

It will be appreciated by those skilled in the art that, without any limitation to the described near-real-time mode of voice communication which is the subject of present invention, the described system is also capable of implementing regular textual “instant messaging”. Even though not required for the purposes of this invention which focuses on voice communication, a preferred embodiment of the present invention includes textual “instant messaging” communication to provide for “all-in-one” messaging experience for its users.

It is appreciated that any of the software components of the present invention may, generally, be implemented in firmware or hardware, if desired, using conventional techniques.

It is appreciated that various features of the invention which are, for clarity, described in the context of separate embodiments may also be provided in combination in a single embodiment. Conversely, various features of the invention which are, for brevity, described in the context of a single embodiment may also be provided separately or in any suitable combination.

It will be appreciated by persons skilled in the art that the present invention is not limited by what has been particularly shown and described hereinabove.

What is claimed is:

1. A system for near-real-time messaging comprising:
a multiplicity of communication devices wherein said multiplicity of communication devices are connected to a network and are operative to receive audio inputs from users;
a multiplicity of messengers wherein said multiplicity of messengers reside within said multiplicity of communications devices;
wherein said multiplicity of messengers allows users to record said audio inputs; and
wherein said multiplicity of messengers allows said users to transmit and receive said recorded audio inputs between said multiplicity of communications devices in near-real-time.

2. The system of claim 1 wherein said recorded audio inputs include at least one of a pre-recorded audio clip, a text version of said pre-recorded audio clip or a text version of one or more of said audio inputs.

3. The system of claim 1 in which one or more of said multiplicity of messengers performs at least one of the following: authorization of users, maintenance of a list of users, or exchanging users' presence information.

4. The system of claim 1 in which one or more of said multiplicity of messengers translates said recorded audio inputs into text.

5. The system of claim 4 in which said text is coupled with said recorded audio inputs such that the content of said recorded audio inputs can be identified through a search of said text.

6. The system of claim 4 in which one or more of said multiplicity of messengers enhance said translation by comparing said recorded audio inputs and said text to a user's voice profile.

7. The system of claim 1 in which one or more of said multiplicity of messengers performs identification and authentication of said recorded audio inputs by comparing said recorded audio inputs to voice profiles of users.

8. The system of claim 1 further comprising an audio message editor wherein said audio message editor allows a user to perform one or more of the following on said recorded audio inputs: edit, enhance, crop, merge, append, superimpose, and store as draft.

9. The system of claim 5 further comprising an audio message editor wherein said audio message editor prompts a user with text translations of said recorded audio inputs to facilitate said user's editing of said recorded audio inputs.

10. The system of claim 1 wherein one or more of said multiplicity of messengers allows said users to schedule said transmission of said recorded audio inputs.

11. The system of claim 1 further comprising at least one server wherein said server is connected to said network and wherein one or more of said multiplicity of messengers reside on said server.

12. The system of claim 1 wherein one or more of said multiplicity of messengers allows said users to intercept said transmission of said recorded audio inputs.

13. A method for near-real-time messaging comprising:
(a) selecting at least one message recipient with a communication device;
(b) recording at least one audio input;
(c) assigning said recorded audio input with a unique identification number;
(d) linking said communication device to at least one other communication device via a network; and
(e) transmitting from said communication device to said at least one other communication device in near-real-time: said unique identification number, said recorded audio input, information identifying the message sender, and information identifying said at least one message recipient.

14. The method of claim 13 wherein said network includes at least one server.

15. The method of claim 13 wherein said recorded audio input is encoded prior to step (e).

16. The method of claim 14 wherein step (b) further comprises streaming said at least one audio input from said communication device to said server and recording said at least one audio input with said server.

17. The method of claim 13 further comprising playing said recorded audio input prior to step (e).

18. The method of claim 13 further comprising editing said recorded audio input prior to step (e).

19. The method of claim 13 wherein said transmitting is scheduled by said message sender.

20. The method of claim 13 further comprising editing said recorded audio input prior to step (e).

21. The method of claim 20 wherein said editing includes one or more of: cropping, merging, superimposing, or storing of said recorded audio input.

22. The method of claim 13 wherein at least one of said communication device or said at least one other communication device is a telephone.

23. The method of claim 13 further comprising translating the speech content of said recorded audio input into text prior to step (e).

24. The method of claim 23 wherein said translating is enhanced by comparing said recorded audio input and said text to a pre-recorded speech profile of said message sender.

25. The method of claim 23 wherein step (e) further comprises transmitting said text.

26. The method of claim 25 further comprising assigning said text a unique identification number that corresponds to said unique identification number assigned to said recorded audio input, transmitting said unique identification of said text, and after said transmitting and step (e), verifying that said transmitted unique identification numbers of said recorded audio input and said text still corresponded to one another.

27. The method of claim 13 further comprising transmitting, after step (e), an intercept message to said at least one other communication device, deleting said transmitted recorded audio input if said intercept message is received by said at least one other communication device prior to the viewing of said transmitted recorded audio input by said message recipient, and notifying said message sender whether said recorded audio input was successfully deleted.
